(19) United States
(12) Patent Application Publication
(10) Pub. No.: US 2007/0146791 A1
(43) Pub. Date: Jun. 28, 2007

(54) PRINTING APPARATUS, PRINTING SYSTEM, PRINTING METHOD, PROGRAM, AND STORAGE MEDIUM

(75) Inventor: Yoko Murase, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Tokyo (JP)

(21) Appl. No.: 11/610,718

(22) Filed: Dec. 14, 2006

(30) Foreign Application Priority Data
Dec. 26, 2005 (JP) 2005-372524

(51) Int. Cl. G06K 15/00

(52) U.S. Cl. 358/1.16

(57) ABSTRACT

A printing apparatus and a method for performing re-printing after correction of an original, the apparatus and method including storing first data including a plurality of pages, inputting second data including a plurality of pages, extracting difference data by comparing the first data and the second data, displaying a preview of the difference data, selecting a page based on the preview, loading a recording medium having the first data printed thereon, and performing an overwrite printing by printing the difference data of the selected page on the loaded recording medium.

### BACKGROUND OF THE INVENTION

1. Field of the Invention

The present invention relates to a printing apparatus, a printing system, a printing method, a program, and a storage medium.

2. Description of the Related Art

In recent years, with a higher printing speed for a copying machine, printing of a large number of copies of print data having the same content can be easily performed. Especially in an office environment, various kinds of information are frequently printed and distributed such as a material for meetings or various memos. In an office environment, information tends to be updated frequently. In some instances, incorrect information is printed and the mistake is only recognized after printing has occurred. When it is necessary to update or correct the content(s) of a printed product, the corrected copy needs to be printed. There are some current methods intended to improve operability in performing the operations described above.

For example, Japanese Patent Application Laid-Open No. 07-038741 discusses a method in which a plurality of data is stored electronically synthesized to print out the synthesized data on one sheet. With this method, in a case where contents for updating are added to the data, a user can synthesize the content to be updated that is newly input with the content that is previously stored to output the synthesized content.

Japanese Patent Application Laid-Open No. 11-272654 discusses a method in which a user first corrects a portion of a printed product to be corrected by hand and scans the corrected printed product. Then, difference data between stored original data and the data read by the scanner is extracted. The extracted difference data is stored while being synthesized with the original data. This method allows a user to more easily correct the stored data.

In the above described methods, it is necessary to perform a new printing operation every time a user corrects the content of a printed product. Accordingly, paper resources are wasted since both a correct and incorrect version of a product have been printed.

### SUMMARY OF THE INVENTION

The present invention is directed to a printing apparatus, a printing system, a printing method, a program, and a storage medium that can facilitate printing without wasting a printed recording medium when performing reprinting after correcting the content(s) of the printed recording medium.

According to an aspect of the present invention, a printing apparatus includes a storage unit configured to store first data including a plurality of pages, an input unit configured to input second data including a plurality of pages by reading an image of an original using a reading apparatus, an extraction unit configured to extract difference data by comparing the first data stored in the storage unit with the second data input by the input unit, a display unit configured to display a preview of the difference data, a selection unit configured to select a page according to a designation by a user, the user designating the page based on the preview displayed by the display unit, a loading unit configured to load a recording medium having the first data printed thereon, and a printing unit configured to perform overwrite printing by printing the difference data of the page selected by the selection unit on the recording medium loaded in the loading unit.

Further feature and aspects of the present invention will become apparent from the following detailed description of exemplary embodiments with reference to the attached drawings.

### BRIEF DESCRIPTION OF THE DRAWINGS

The accompanying drawings, which are incorporates in and constitute a part of the specification, illustrate exemplary embodiments, features, and aspects of the invention and, together with the description, serve to explain the principle of the invention.

FIG. 1 illustrates a functional configuration of a multifunction peripheral according to an exemplary embodiment of the present invention.

FIG. 2 illustrates a system configuration according to an exemplary embodiment of the present invention.

FIG. 3 illustrates an exemplary hardware configuration of a multifunction peripheral according to an exemplary embodiment of the present invention.

FIG. 4 illustrates an exemplary configuration of an operation unit according to an exemplary embodiment of the present invention.

FIG. 5 illustrates a user authentication screen of the operation unit according to an exemplary embodiment of the present invention.

FIG. 6 illustrates a copy initial screen of the operation unit according to an exemplary embodiment of the present invention.

FIG. 7 illustrates a send/fax initial screen of the operation unit according to an exemplary embodiment of the present invention.

FIG. 8 illustrates a box initial screen of the operation unit according to an exemplary embodiment of the present invention.

FIG. 9 illustrates a user box subscreen according to an exemplary embodiment of the present invention.

FIG. 10 illustrates a screen for prompting a user to set an overwriting original according to an exemplary embodiment of the present invention.

FIG. 11 illustrates a data preview screen according to an exemplary embodiment of the present invention.

FIG. 12 illustrates a screen for prompting a user to set a print paper according to an exemplary embodiment of the present invention.

FIG. 13 is a flow chart that illustrates a series of processings by an overwrite printing processing according to an exemplary embodiment of the present invention.

FIG. 14 illustrates a screen for selecting an updated data input method according to an exemplary embodiment of the present invention.

FIG. 15 illustrates a screen for selecting updated data according to an exemplary embodiment of the present invention.

FIG. 16 is a flow chart that illustrates a series of processings by an overwrite printing processing according to an exemplary embodiment of the present invention.

FIG. 17 illustrates a user box subscreen according to an exemplary embodiment of the present invention.

FIG. 18 illustrates a screen for selecting an overwriting page according to an exemplary embodiment of the present invention.

FIG. 19 illustrates a screen for prompting a user to set an overwriting original according to an exemplary embodiment of the present invention.

FIG. 20 illustrates a data preview screen according to an exemplary embodiment of the present invention.

FIG. 21 illustrates a screen for selecting an arranging order of papers according to an exemplary embodiment of the present invention.

FIG. 22 illustrates a screen for prompting a user to set print papers according to an exemplary embodiment of the present invention.

FIG. 23 is a flow chart that illustrates a series of processings by an overwrite printing processing according to an exemplary embodiment of the present invention.

### DETAILED DESCRIPTION OF THE EXEMPLARY EMBODIMENTS

Various exemplary embodiments, features, and aspects of the invention will be described in detail below with reference to the drawings. It should be noted that the relative arrangement of the components, the numerical expressions and numerical values set forth in these embodiments do not limit the scope of the present invention unless it is specifically stated otherwise.

### First Exemplary Embodiment

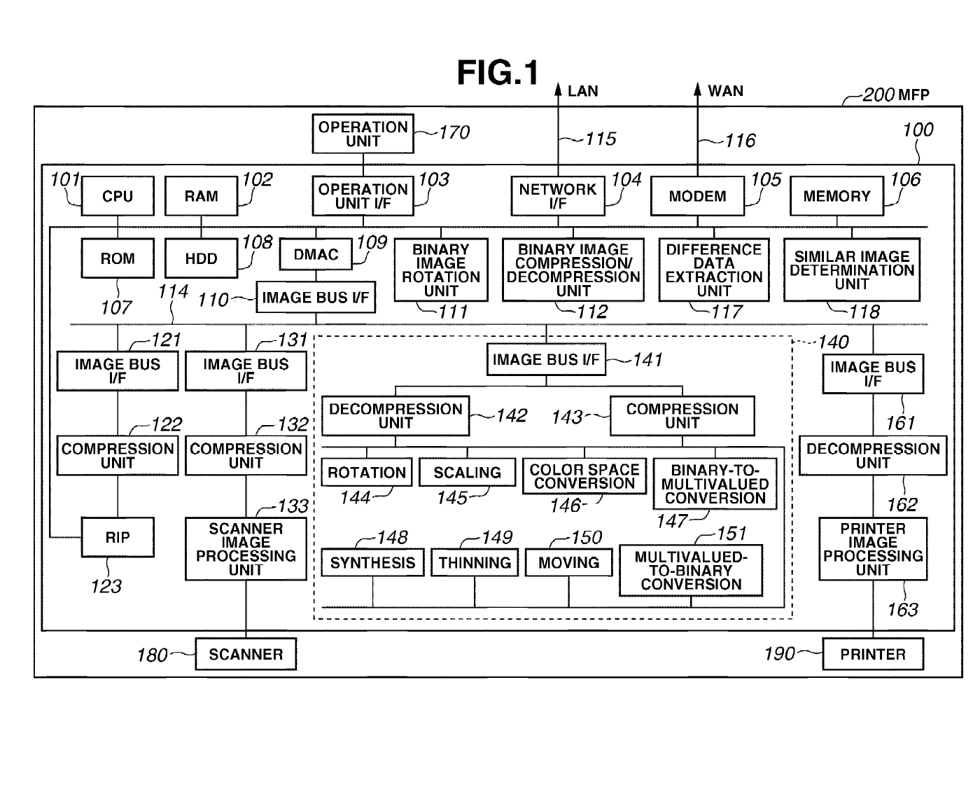

FIG. 1 illustrates an exemplary functional configuration of a multifunction peripheral 200 according to a first exemplary embodiment of the present invention. Referring to FIG. 1, a controller unit 100 is connected to a color scanner 180, which is an image input device, and a color printer 190, which is an image output device. In addition, the controller unit 100 is connected to a local area network (LAN) 115 and a wide area network (WAN) (public line) 116. The controller unit 100 inputs and outputs image information and device information to and from the LAN 115 or the WAN 116.

A CPU 101 controls an operation of the multifunction peripheral 200 and operates according to a program stored in a random access memory (RAM) 102. In addition, the RAM 102 serves also as an image memory that temporarily stores image data. A read-only memory (ROM) 107 is a boot ROM that stores a system boot program. A hard disk drive (HDD) 108 stores system software, image data, and a program for controlling an operation of the multifunction peripheral 200. The program stored in the HDD 108 is loaded to the RAM 102, and the CPU 101 controls an operation of the multifunction peripheral 200 based on the loaded program.

An operation unit interface (I/F) 103 is an interface for connecting an operation unit 170 and the controller unit 100. The operation unit I/F 103 outputs image data to be displayed by the operation unit 170 to the operation unit 170. In addition, the operation unit I/F 103 sends information input by a user via the operation unit 170 to the CPU 101. A network I/F 104 is connected to the LAN 115 and controls the input and output of various information. A modem 105 is connected to the WAN 116 and controls the input and output of image information.

A binary image rotation unit 111 and a binary image compression/decompression unit 112 respectively perform a processing for converting an orientation of an image and for converting a resolution of an image into a given resolution or to a resolution corresponding to an ability of a receiving apparatus. The binary image compression/decompression unit 112 compresses and decompresses data by using JBIG, MMR, MR, or MH.

A direct memory access controller (DMAC) 109 reads image data stored in the RAM 102 without using the CPU 101 and transfers the read image data to an image bus I/F 110. In addition, the DMAC 109 writes image data sent from the image bus I/F 110 onto the RAM 102 without using the CPU 101. Each unit described above is mutually connected via a system bus 114.

Image bus I/Fs 110, 121, 131, 141, and 161 are interfaces for controlling the input and output of image data at a high speed via the system bus 114. Compression units 122, 132, and 143 respectively perform processing for JPEG-compressing image data by a unit of 32×32 pixels before sending image data to the image buses 121, 131, and 141. Decompression units 142 and 162 respectively perform processing for decompressing image data sent via the image buses 141 and 161.

A raster image processor (RIP) 123 receives PDL code from a host computer via the network I/F 104. The CPU 101 stores the received PDL code in the RAM 102 via the system bus 114. The CPU 101 converts the PDL code into intermediate code, then inputs the intermediate code to the RIP 123 via the image bus 114 again, and then rasterizes the input intermediate code into a bitmap image (multivalued image). A scanner image processing unit 133 performs various image processings (e.g., correction processing and editing processing) on a color image and a monochromatic image from a scanner 180 and outputs the color/monochromatic image. In a similar manner, a printer image processing unit 163 performs various image processings (e.g., correction processing and editing processing) on an image to be output to a printer 190. At this time, the decompression unit 162 converts a binary image into a multivalued image, and accordingly, the image can be output as a binary or multivalued image.

An image conversion unit 140 includes various image conversion functions used in converting an image stored in the RAM 102 and returning the converted image to the RAM 102. A rotation unit 144 is capable of rotating an image having 32×32 pixels at a specified angle. The rotation unit 144 is capable of inputting and outputting binary and/or multivalued images. A scaling unit 145 converts a resolution of an image (from 600 dpi to 200 dpi, for example) and performs scaling on an image (from 25% to 400%, for example). A color space conversion unit 146 converts an image that is input as a multivalued image, for example, a YUV image stored in the memory 106, into a Lab image by using a matrix operation so as to store the Lab image in the memory 106. In addition, the color space conversion unit 146 is capable of performing background color removal processing and anti-offset processing.

A binary-to-multivalued conversion unit 147 converts an image having 1-bit binary data per pixel into an image having 256 gradations (8 bits). In addition, a multivalued-to-binary conversion unit 151 converts an image having 256 gradations (8 bits) into an image having 1-bit binary data by using a method such as error diffusion processing to store the converted image in the memory 106.

A synthesis unit 148 includes a function for synthesizing different two types of multivalued (or binary) images into one multivalued (binary) image. Thus, for example, a corporate logo can be synthesized with an original image. Methods of synthesizing can include, but are not limited to, a method in which values are averaged per one pixel, a method in which a pixel value of an image brighter in terms of brightness is set to be a pixel value after the synthesis, or a method in which a pixel value of an image darker in terms of brightness is set to be a pixel value after the synthesis.

A thinning unit 149 converts a resolution by thinning out pixels of a multivalued image. The thinning unit 149 is capable of outputting a multivalued image having an amount of pixels that is ½, ¼, or ⅛ of an amount of pixels of an original multivalued image. By combining the thinning processing and the scaling processing, an image can be magnified and reduced in a wider scale. A moving unit 150 performs processing for adding a marginal portion to an input image and deleting a marginal portion from an input image. The rotation unit 144, the scaling unit 145, the color space conversion unit 146, the binary-to-multivalued conversion unit 147, the synthesis unit 148, the thinning unit 149, the moving unit 150, and the multivalued-to-binary conversion unit 151 operate in conjunction with each other.

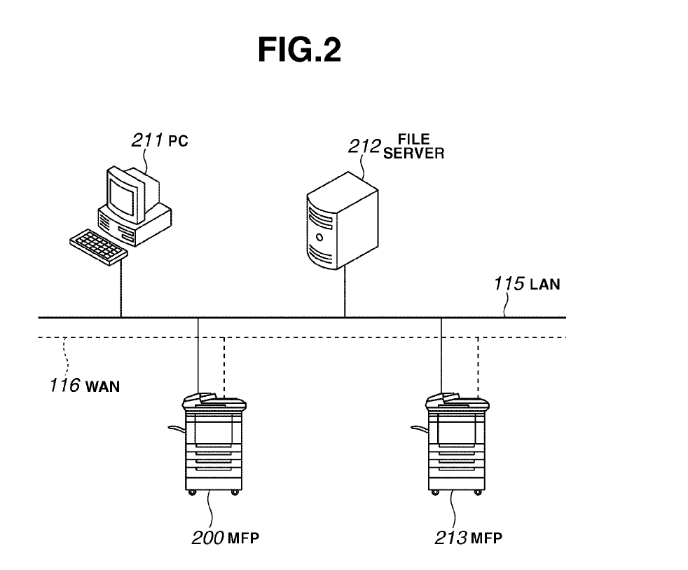

FIG. 2 illustrates a system configuration according to the first embodiment. The multifunction peripheral 200, which is described with reference to FIG. 1, is connected to the LAN 115 and the WAN 116. On the LAN 115, in addition to the multifunction peripheral 200, a PC 211, a file server 212, and a multifunction peripheral 213 are connected. The multifunction peripheral 200 is capable of sending and receiving a file using FTP or SMB protocol and sending and receiving an e-mail via a mail server that is separately provided. In addition, the multifunction peripheral 200 is capable of accessing a storage area provided in the file server 212 to acquire a file stored in the storage area and storing image data read by the scanner 180 into the storage area in the file server 212. In addition, the multifunction peripheral 200 is capable of sending and receiving a file and an e-mail to and from the MFP 213 and sharing a storage area with the MFP 213.

The MFP 213 and other facsimile terminals are provided on WAN 116. Thus, a facsimile communication using a facsimile protocol can be performed using the multifunction peripheral 200.

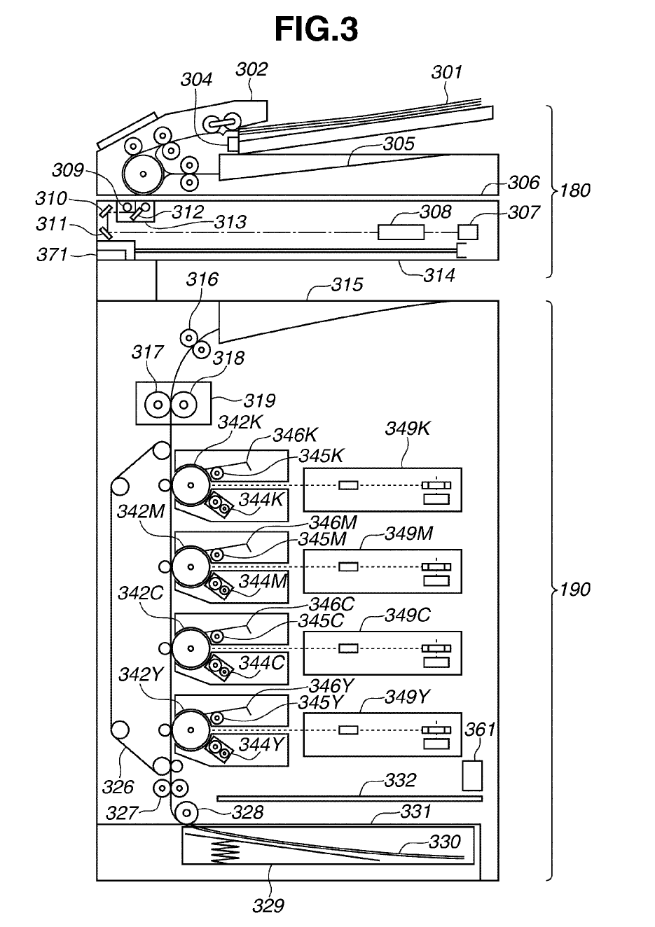

FIG. 3 illustrates an exemplary hardware configuration of the multifunction peripheral 200. Referring to FIG. 3, the multifunction peripheral 200 includes a housing 315 of the printer 190, a document feed unit 302 that feeds a sheet-like original, and a scanner unit 314 for reading an original, which are integrally provided. The housing 315 includes each unit that constitutes the printer 190, an engine control unit 361 that performs control related to each print processing by each unit, and a control board containing unit 332 for containing the controller unit 100 illustrated in FIG. 1.

The multifunction peripheral 200 is capable of printing in full colors using four toners of cyan (C), magenta (M), yellow (Y), and black (B). In addition, the multifunction peripheral 200 includes photosensitive drums 342 (342C, 342M, 342Y, and 342K) that are image bearing members for the four colors, which are installed in tandem in a vertical direction of the multifunction peripheral 200. Charging devices 345 (345C, 345M, 345Y, and 345K) evenly charge a surface of the photosensitive drum 342 of each of the four colors. Print scanner units 349 (349C, 349M, 349Y, and 349K) irradiate a laser beam based on image information for each colors of C, M, Y, and K, and form an electrostatic latent image on the photosensitive drum 342 for each color. Development devices 344 (344C, 344M, 344Y, and 344K) cause toners to adhere to the electrostatic latent image on the photosensitive drum 342 for each color so as to develop the electrostatic latent image as a toner image. An electrostatic carrier/transfer device (not shown) transfers the toner image on the photosensitive drum 342 onto a print paper. Cleaning devices 346 (346C, 346M, 346Y, and 346K) remove the toner remaining on the surface of the photosensitive drum 342 after the transfer.

An electrostatic carrier belt 326 is a belt member that moves in a circulated manner to oppose to and to contact all the photosensitive drums 342. The electrostatic carrier belt 326 is supported in a vertical direction by rollers at four shafts. The electrostatic carrier belt 326 electrostatically attracts a print paper to a circumferential side thereof, and moves in a circulated manner to allow the print paper to contact the photosensitive drum 342. Thus, the print paper is conveyed to a transfer position by the electrostatic carrier belt 326, and toner images on the photosensitive drum 342 are serially transferred onto the print paper.

A paper feed unit 331 feeds print paper to an image formation unit. A plurality of print papers are stacked in a paper feed cassette 329. At the time of forming an image, a paper feed roller 328 and a registration roller pair 327 rotate in a driving manner according to an operation of image forming so as to separate and feed print papers 330 stacked in the paper feed cassette 329 sheet by sheet. In addition, a leading edge of the print paper abuts onto the registration roller pair 327, pauses, forms a loop, and then is fed again onto the electrostatic carrier belt 326. The paper feed cassette 329 is capable of stacking various kinds of recording media, such as an OHP sheet, onto which an image can be formed by the printer 190.

A fixation unit 319 fixes four-color toner images transferred onto a print paper. The fixation unit 319 includes a heat roller 318 that drives and rotates and a pressure roller 317 that contacts the heat roller 318 to apply heat and pressure to the print paper. That is, the print paper onto which the toner image on the photosensitive drum 342 is transferred is conveyed by a fixation roller pair 317 and 318 at the time of passing through the fixation unit 319. Heat is then is applied with heat and pressure by the fixation roller pair 317 and 318, and the four-color toner images are serially fixed onto the surface of the print paper. After that, the print paper onto which the toner images are fixed is discharged to a discharge portion (not shown) by a discharge roller pair 316.

The multifunction peripheral 200 is also capable of capturing image data obtained by reading an image on an original from the scanner 180. The document feed unit (DF unit) 302 of the scanner 180 feeds an original 301 sheet by sheet in order from top to bottom onto a platen glass plate 306, based on control by a scanner control unit 371. After the image on the original is read by the scanner unit 314, the original placed on the platen glass plate 306 is discharged onto a discharge tray 305.

A sensor 304 detects the presence or absence of an original. The scanner unit 314, when an original is conveyed onto the platen glass plate 306, turns on a lamp 309, starts moving an optical unit 313, and then performs exposure scanning of the original. At this time, reflected light from the original is guided to a CCD image sensor (hereinafter referred to as a “CCD”) 307 via mirrors 312, 310, and 311 and a lens 308.

The image on the original scanned in the above-described manner is read by the CCD 307. Image data output from the CCD 307 is transferred to the controller unit 100.

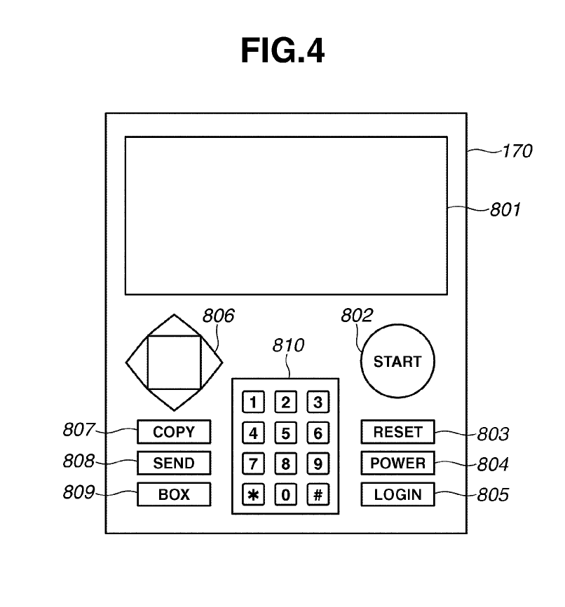

FIG. 4 illustrates an exemplary configuration of the operation unit 170. A liquid crystal panel unit 801 displays a screen that allows a user to operate the multifunction peripheral 200. In addition, the liquid crystal panel unit 801 displays a preview of an image stored in the RAM 102 or the HDD 108, device information including a printing status, and a result of various processings. The liquid crystal panel unit 801 is a touch panel that detects positional information of a point at which a user touches to allow the user to input various instructions via the liquid crystal panel unit 801. A start button 802 is a button a user selects in instructing a start of a copying function, a sending function, and the like.

The operation unit 170 includes other hard keys such as a reset button 803 for resetting the multifunction peripheral 200, a power button 804 for turning on and off the multifunction peripheral 200, numeral keys 810 for inputting the number of copies and other values, and a cursor key 806 for operating a cursor displayed on the liquid crystal panel unit 801. In addition, the operation unit 170 includes mode keys for switching between functional modes of the multifunction peripheral 200, such as a copy key 807, a send key 808, and a box key 809.

A login key 805 is a key selected by a user for user authentication before operating the multifunction peripheral 200. If a user selects the login key 805 when the user is already logged in, the user can log out. A detailed description for the operation for user authentication is described below.

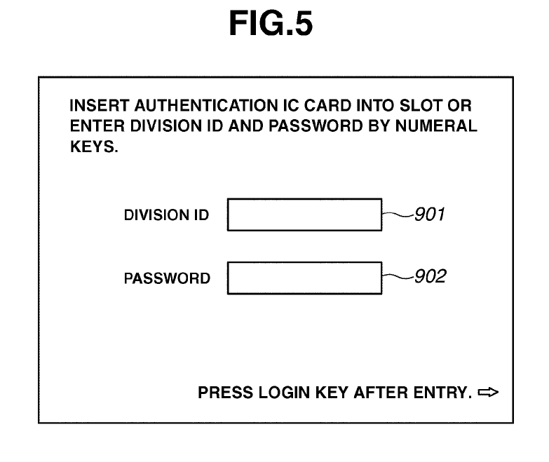

FIG. 5 illustrates an example of a screen displayed on the liquid crystal panel unit 801 of the operation unit 170. More specifically, FIG. 5 illustrates a screen for entering a division ID and a password used for authenticating a user to allow the user to log in before the user operates the multifunction peripheral 200. When the user enters an ID in an ID entry field 901, a password in a password entry field 902, and selects the login key 805 illustrated in FIG. 4, each entered information and user information previously registered in the memory 106 are compared to each other. When the information matches each other, the user is permitted to log in.

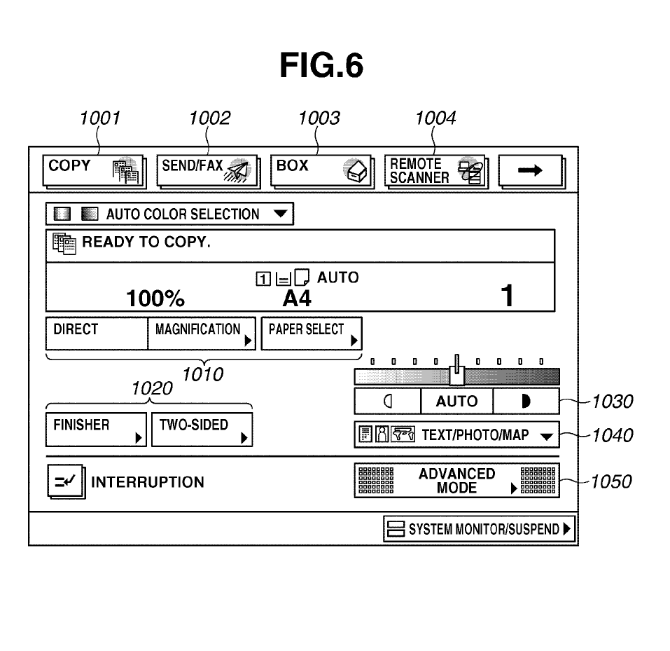

FIG. 6 illustrates a copy initial screen first displayed when the user logs in. Tabs displayed on the screen are mode keys 1001 through 1004 for switching between functional modes of the multifunction peripheral 200. In performing copying processing in which image data is input by the scanner 180 and the image data is output by the printer 190, the user performs a detailed setting through the copy initial screen, and after that, the user selects the start button 802 to start the processing. Buttons 1010 are selected by the user to specify a print magnification and a paper size. Buttons 1020 are selected by the user to specify a paper discharge method and whether an original is a one-sided original or a two-sided original. Buttons 1030 are selected by the user to specify a print density. A button 1040 is selected by the user to specify a text reading mode and a photograph reading mode. A button 1050 is selected by the user in performing detailed settings other than described above.

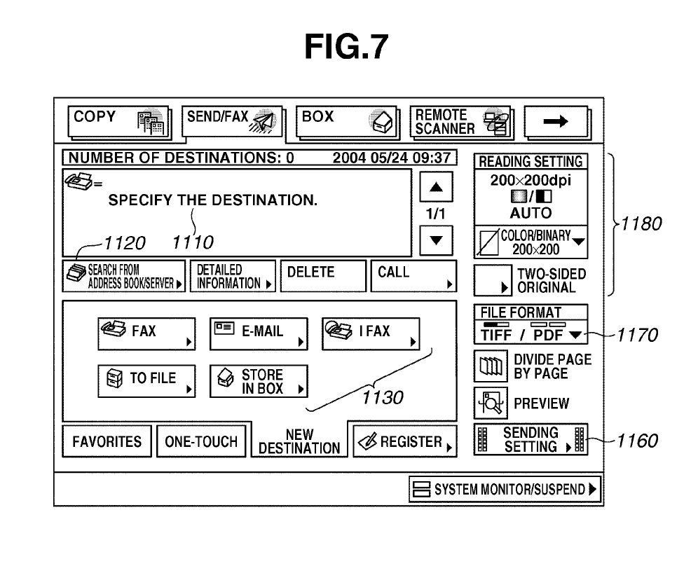

FIG. 7 illustrates a send/fax initial screen displayed when the user selects the send/fax mode key 1002. The user performs a detailed setting in the case of sending data input by the scanner 180 to an external device, storing the data input by the scanner 180 in a storage area (box) provided in the multifunction peripheral 200, or sending and receiving facsimile data.

A destination display field 1110 displays a destination selected from an address book, which is described below. A “search from address book/server” button 1120 is selected to read sending destination information previously set to set the destination information as a destination. Sending method selection buttons 1130 are selected to display a screen for performing a detailed setting according to a sending method such as a fax sending or an e-mail sending. For example, in the case of sending an Internet facsimile (I fax) by which image data is sent by a facsimile transmission using e-mail protocol, the user can set an e-mail address of a sending destination, a resolution, and a compression method.

When the user makes a selection in a reading setting field 1180, the user can set detailed settings in reading an image on an original and inputting data by using the scanner 180. A file format specification button 1170 is selected to specify a format of a file to be sent. A sending setting button 1160 is selected to set a detailed setting in the case of sending encrypted data and sending data with a password added thereto.

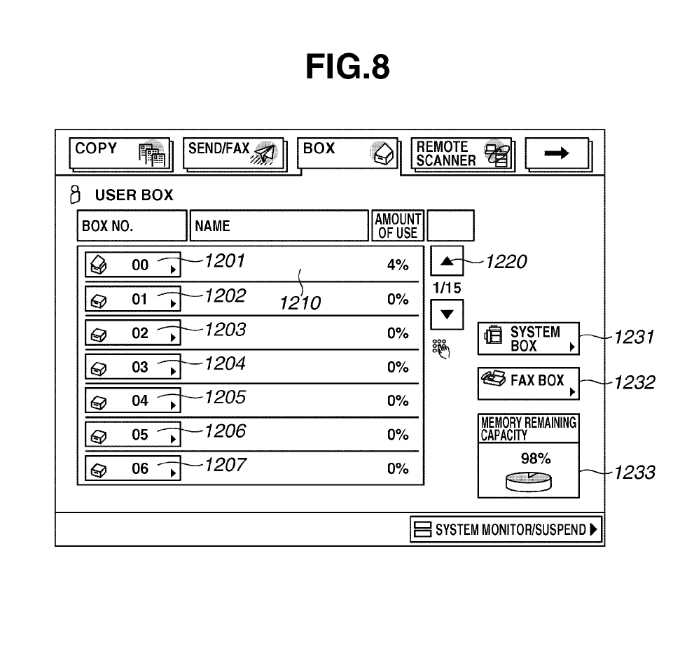

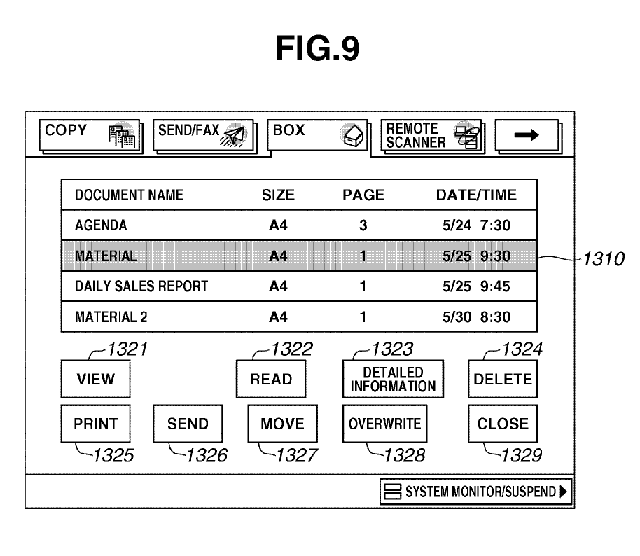

FIG. 8 illustrates a box initial screen displayed when the user selects the box mode key 1003. A box is a storage area in the HDD 108 allocated for each individual user. Various data can be stored in the box. The screen includes box selection buttons 1201 through 1207, a box scroll button 1220, a system box button 1231, a fax box button 1232, a memory remaining capacity display area 1233, and a box name display area 1210. When the user selects one of the box selection buttons 1201 through 1207, a user box subscreen, described below with reference to FIG. 9, is displayed. When the user selects the box scroll button 1220, box numbers to be displayed are scrolled up or down.

When the user selects the system box button 1231, a system box subscreen (not shown), which illustrates a list of data received by using a communication function, is displayed. When the user selects the fax box button 1232, a fax box subscreen (not shown) is displayed. A fax box stores data received through a facsimile transmission. When the user selects a box selection button displayed in the fax box subscreen, a list of stored received data is displayed. In the memory remaining capacity display area 1233, a remaining capacity of a document storage area in the HDD 108 is displayed. In the box name display area 1210, a name that is set for each box number is displayed.

FIG. 9 illustrates a user box subscreen. The user box subscreen includes a storage data display area 1310, a view button 1321, a read button 1322, a detailed information display button 1323, a delete button 1324, a print button 1325, a send button 1326, a move button 1327, an overwrite button 1328, and a close button 1329. When the user selects the read button 1322 while the user box subscreen is displayed, the data obtained by reading an image on an original by the scanner 180 can be stored in a user box currently displayed.

In the stored data display area 1310, attribute information of data such as document data and image data stored in the HDD 108 is displayed in a list. When the user selects desired data, an area for the selected data is shaded as illustrated in FIG. 9, to indicate a selected area. When the user selects the view button 1321 in a state where the data is selected, a preview of the selected data is displayed. In addition, when the user selects the detailed information button 1323 in the state where the data is selected, more detailed information as to the selected data (e.g., a producer of the data and apparatus information of an apparatus by which the data is produced) is displayed. When the user selects the delete button 1324 in the state where the data is selected, the selected data is deleted.

When the user selects the print button 1325, the user can print out the selected data using the printer 190. When the user selects the send button 1326, the user can send the selected data by using either one of or a combination of the various sending methods described above. When the user selects the move button 1327, the user can move the selected data to another user box or to another storage area. When the user selects the overwrite button 1328, the user can extract difference data between the selected data and newly input data and execute an overwrite printing function.

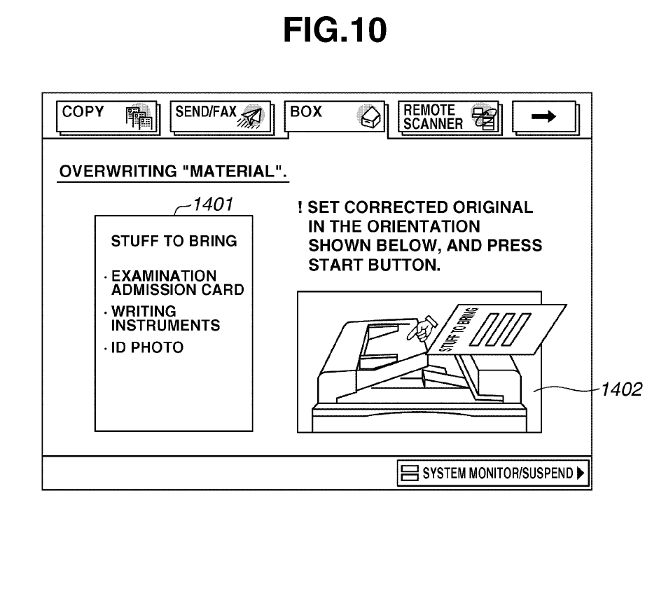

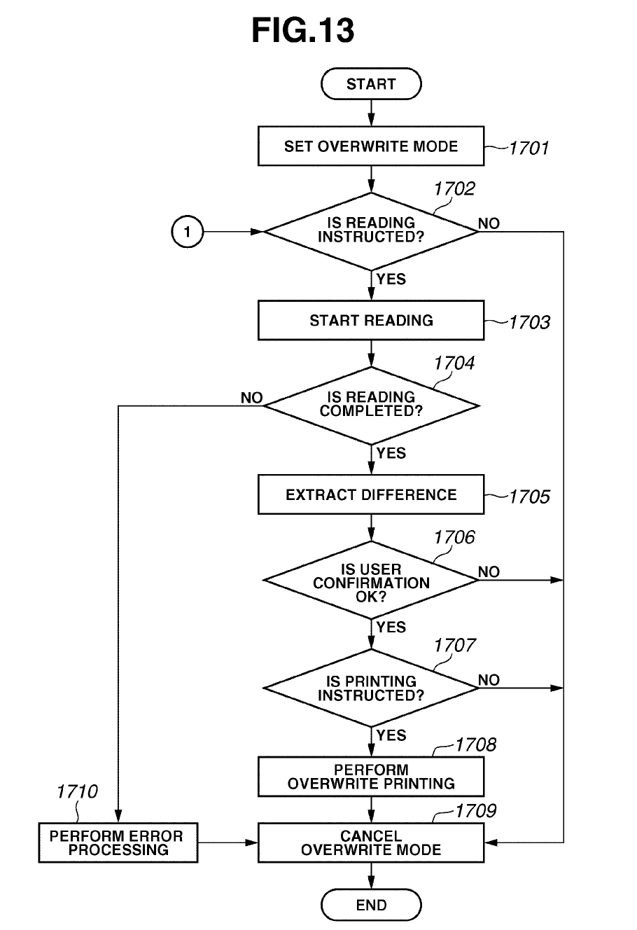

Now, an operation and a flow of processing in operating the overwrite printing is described below with reference to the screens illustrated in FIGS. 10 through 12 and a flow chart illustrated in FIG. 13. FIG. 13 is a flow chart that illustrates an operation of control by the CPU 101 of the multifunction peripheral 200 in performing the overwrite printing.

First, when the user selects the overwrite button 1328 in a state where desired data (hereinafter referred to as “original data”) is selected in the screen illustrated in FIG. 9, a screen illustrated in FIG. 10 is displayed. This processing corresponds to the setting for the overwrite mode in step 1701 in the flow chart of FIG. 13. Note that in the first embodiment, only one piece of original data is selected. The screen illustrated in FIG. 10 illustrates a procedure for inputting data to the selected original data based on a content after updating (hereinafter referred to as “updated data”) by reading an image in an original whose content is updated.

In a display area 1401, a preview image of the original data is displayed. In the example illustrated in FIG. 10, a preview of data “material”, which is selected in the screen illustrated in FIG. 9, is shown. By this display, the user can reconfirm the content to be overwrite-printed, and accordingly, a failure in printing occurring due to overwrite processing to data including a wrong content can be prevented. The overwrite processing is described below. In a display area 1402, a procedure is displayed so that a right side and orientation can be recognized in setting an updated original into the document feed unit 302 by using a preview image of the original data. In the present embodiment, difference data between the original data and the updated data is extracted as described below. Accordingly, if the original is set in a wrong orientation, ineffective difference data is undesirably extracted. As described above, the procedure is displayed in the display area 1402, and thus the user can confirm the orientation of setting the original. Note that in the example illustrated in FIG. 10, a preview image of the original data is used. However, the method for displaying the side and orientation of setting the original according to the first embodiment is not limited to this.

When the user selects the start button 802 after setting the original in the scanner 180 according to the procedure illustrated in the display area 1402, the reading of the original by the scanner 180 begins. This instruction by the user corresponds to processing in step 1702 in the flow chart illustrated in FIG. 13. When the user selects the start button 802, the processing advances to step 1703 to start reading the original. If a given period of time elapses in a state where the screen illustrated in FIG. 10 is displayed or when the user selects the reset key 803, it is determined that an instruction for reading is not issued in step 1702. Then, the processing advances to step 1709 to cancel the overwrite mode, and then the processing ends.

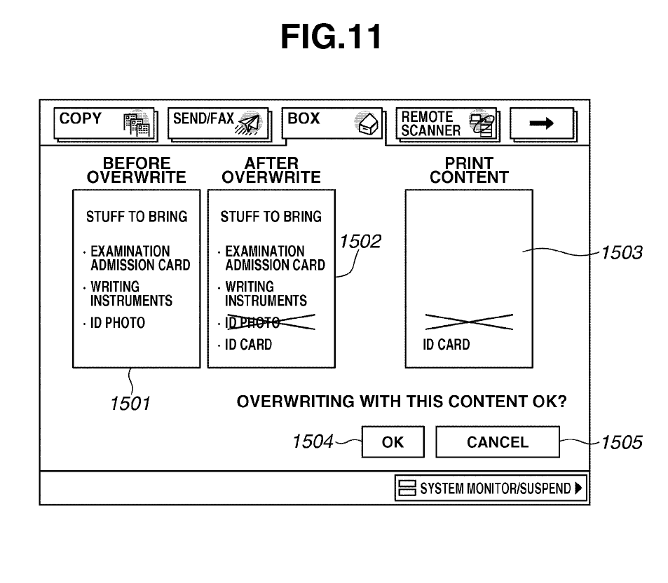

In step 1704, the CPU 101 determines whether the reading of the image on the original is completed. If it is determined in step 1704 that the reading of the image on the original is completed, a confirmation screen illustrated in FIG. 11 is displayed. If, for example, a paper jamming occurs in the scanner 180 in reading the image on the original, that is, if the reading of the image on the original is not completed, the processing advances to step 1710. In step 1710, the CPU 101 performs error processing, and then cancels the overwrite mode in step 1709. The processing then ends. In the error processing, a message indicating that an error occurs is displayed by the liquid crystal panel unit 801 or notified to a previously set user. If it is determined that the reading of the image on the original is completed in step 1704, the processing advances to step 1705. In step 1705, the CPU 101 causes a difference data extraction unit 117 to extract a difference between the original data and the updated data (hereinafter referred to as “difference data”). Then, the processing advances to step 1706. In step 1706, the screen illustrated in FIG. 11 is displayed by the liquid crystal panel unit 801.

The extraction of the difference data by the difference data extraction unit 117 according to the first embodiment is performed in a manner such that the original data is rasterized into a bitmap image first, and then the bitmap image is compared with the updated data to extract a difference. Any method for extracting a difference that would enable practice of the present invention is applicable. For example, an optical character recognition (OCR) technique in which a difference is extracted by comparing character codes included in the original data with character codes included in the updated data obtained by the OCR technique can be used. In another example, a graphic recognition technique in which a difference is extracted by comparing a graphic included in the original data and expressed by a given function with a graphic obtained by the graphic recognition can be used.

In addition, difference data can be produced by using the OCR recognition technique or a vectorization technique in which a straight line, a curve, and a closed region are automatically produced by a function, based on a difference image extracted by the comparison of the bitmap image with the original image. Thus, a content of an update performed by handwriting can be converted into character fonts, a straight line, or a curve. In addition, an editing operation such as an insertion, a line feed, and a deletion can be automatically performed by recognizing editing symbols for insertion, line break, and deletion.

FIG. 11 illustrates an example of a screen displayed when the reading of the original for overwriting is completed. In a display area 1501, a preview image of the original data is displayed as “before overwrite”. In a display area 1502, a preview image of the updated data is displayed as “after overwrite”. In this example, it can be seen that the “material” that is printed as the original data includes a “stuff to bring” such as an “examination admission card”, “writing instruments”, and an “ID photo”, but the content of the “stuff to bring” is changed via a hand mark-up to include an ID card instead of the ID photo.

In a display area 1503, a preview image of the difference data extracted in step 1705 in the flow chart of FIG. 13 is displayed as a “print content”. More specifically, as illustrated, only a mark “X” and a character string “ID card”, which are added to the original data via hand mark-ups, are extracted to be ready as print data for overwriting. Note that in the case of the image data illustrated in FIG. 11, for example, the character string “ID photo” and the mark “X” are overlapped, and accordingly, by comparing in a state of the bitmap image, portions of the mark “X” that overlap the character string “ID photo” are not extracted as a difference. In such a case, by interpolating the lacking portions of the mark “X”, more accurate difference data can be obtained.

When the content displayed by the preview is satisfactory to the user, the user selects an OK button 1504. On the other hand, if the user wishes to redo the reading, the user selects a cancel button 1505. In this case, referring to the flow chart of FIG. 13, if the user selects the OK button 1504, the processing advances to step 1707. On the other hand, if the user selects the cancel button 1505, the processing advances to step 1709 to cancel the overwrite mode, and then the processing ends. Note that in the present example, the overwrite mode ends upon selection of the cancel button 1505. However, in another example, the processing can be arranged such that after the cancel button 1505 is selected in step 1706, the processing returns to step 1703 to perform the processing again from the step of reading the image on the original.

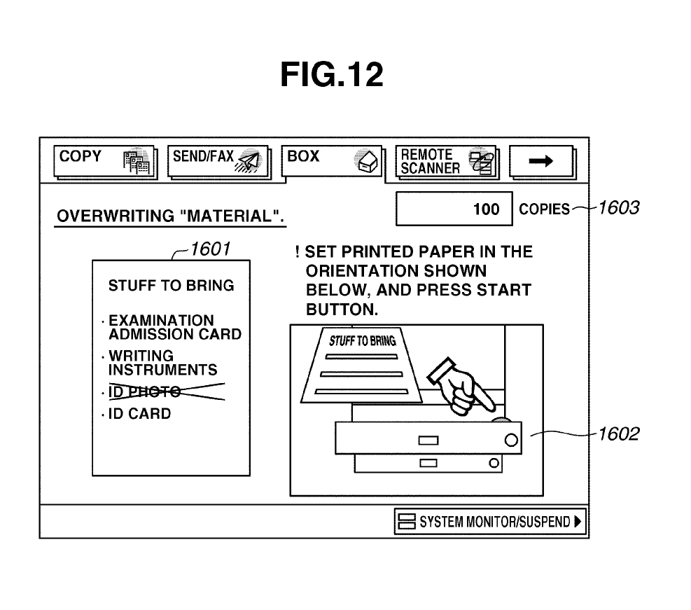

If, in step 1706, it is determined that the OK button 1504 is selected, the processing advances to step 1707 to determine if the user has generated an instruction to perform printing. At this time, the liquid crystal panel unit 801 displays a screen illustrated in FIG. 12.

FIG. 12 illustrates a screen for prompting the user to set a printed paper after the difference data is produced. In a display area 1601, a content of the completed output after the overwrite printing, namely, a preview image of the original read in step 1703, is displayed. In a display area 1602, a procedure for setting the printed paper having the original data printed thereon into the paper feed cassette 329 is displayed, using the preview image of the original data. In the present embodiment, since the difference data is overwritten onto the printed paper having the original data printed thereon to print the updated data, the printed paper is required to be set in a right side and orientation. Accordingly, by displaying the procedure for setting the printed paper, the user can easily recognize the side and the orientation for setting the printed paper. Note that in this example, the printed paper is set into the paper feed cassette 329. However, the location of stacking the printed papers is not limited to the paper feed cassette 329. That is, the configuration can be arranged such that the printed papers are set from a manual feed tray (not shown).

In a display area 1603, the number of copies to be produced by the overwrite printing entered by the user through the hard keys 810 is displayed. In the present embodiment, the user specifies the number of copies to be produced by the overwrite printing as illustrated in FIG. 12. Specifying the number of prints to make is not limited to the above described method, and any method that would enable practice of the present invention is applicable. For example, information indicating the setting for the number of copies at the time of printing data is stored as a print history and when the data is specified as the “original data” for the overwrite printing based on the print history, the number of copies to be produced by the overwrite printing is automatically set based on the stored information as to the number of copies to make. Thus, in this method, the user does not need to enter the number of copies.

When the printed print is completely set, the user selects the start button 802 to start printing. This instruction corresponds to the processing in step 1707. When the user selects the start button 802, the processing advances to step 1708. In step 1708, the overwrite printing for the number of copies set in the display area 1603 begins. If a given period of time elapses without any operation by the user in a state where the screen illustrated in FIG. 12 is displayed, or if the reset key 803 is selected by the user, it is determined in step 1707 that no instruction for printing has been issued. Then, the processing advances to step 1709 to cancel the overwrite mode. The processing then ends. When the overwrite printing is completed in step 1708, the processing advances to step 1709 to cancel the overwrite mode. The processing then ends.

Note that in the present exemplary embodiment, the preview images of the original data and the updated data are used to allow the user to confirm if the original data and the updated data form a right combination. However, any other confirmation method that would enable practice of the present invention is applicable. For example, additional information such as a two-dimensional bar code or quick response (QR) code is added to each data for printing by using a publicly known technique so that the data is made to be recognizable by the user by reading by the scanner 180. Then, instead of the user confirming using the screen illustrated in FIG. 11, the additional information of each of the original data and the updated data is recognized to automatically determine whether the original data and the updated data are based on the same data. In addition, by recognizing the additional information at the time of setting the original to be read and the printed paper for printing, it is determined whether the set orientation is right or wrong, and if the printed paper is set in a wrong orientation, a warning is issued. Furthermore, the orientation of the original and the printed paper can be adjusted by automatically rotating the image data. As described above, a part of the function of the overwrite printing can be automated by using additional information.

In the present exemplary embodiment, as described above, the overwrite printing can be performed by reading a printed paper which includes a newly corrected content and extracting difference data. Accordingly, the waste of a print paper that was used once for printing can be prevented.

### Second Exemplary Embodiment

A second exemplary embodiment of the present invention is described below. Portions of the configuration that are similar to those of the configuration of the first exemplary embodiment are provided with the same reference numerals and symbols, and their descriptions are omitted herein. One difference of the second exemplary embodiment from the first exemplary embodiment is that in the first exemplary embodiment, an image on an original that is corrected in inputting updated data is read by the scanner 180, while in the second exemplary embodiment, data that is already stored is used as updated data.

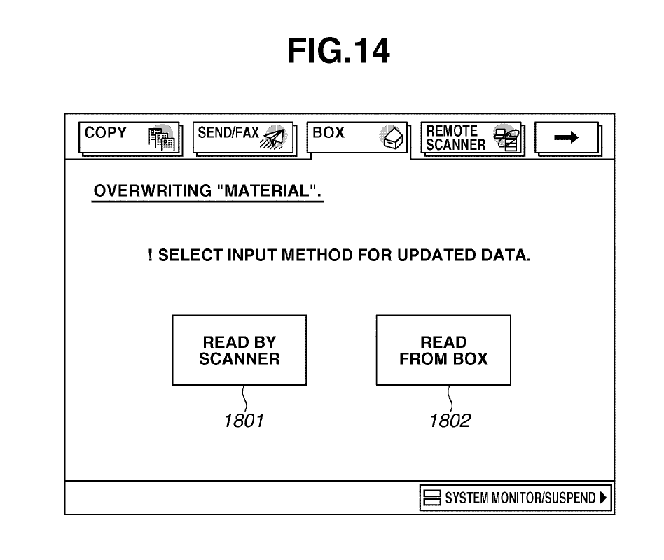

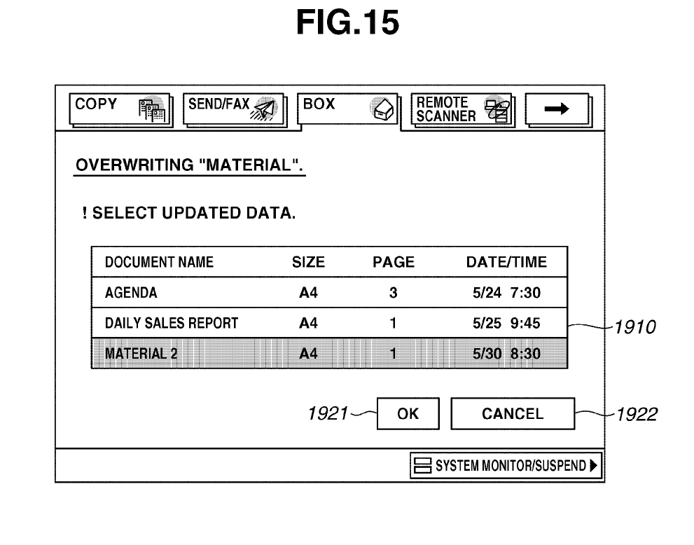

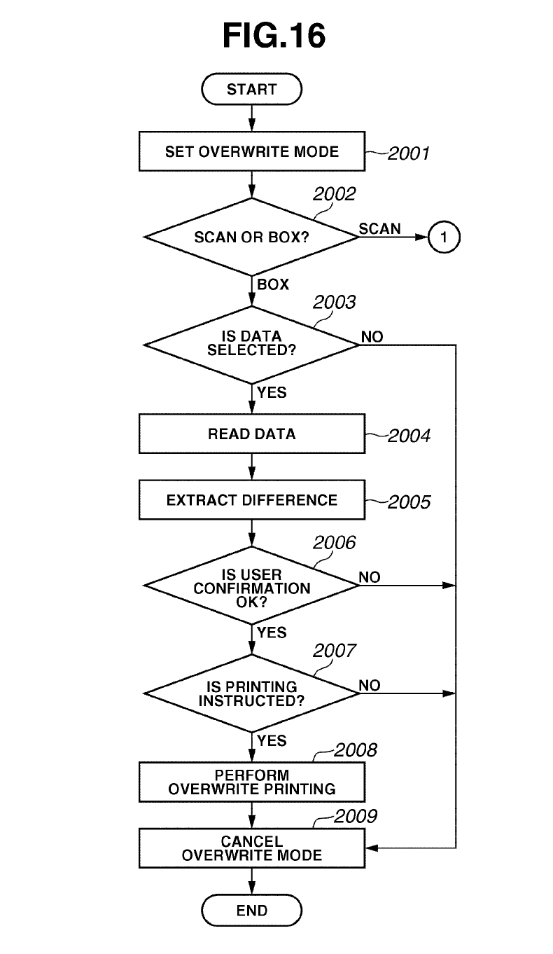

The operation and the flow of processing of the overwrite printing are described in detail with reference to the screens illustrated in FIGS. 14 and 15 and the flow chart illustrated in FIG. 16. FIG. 16 is a flowchart that illustrates the operation of control by the CPU 101 of the multifunction peripheral 200 in performing the overwrite printing.

First, in the screen illustrated in FIG. 9, as in the case of the first embodiment, data that is to be overwritten (hereinafter referred to as “original data”) is selected by the user. Then, when the user selects the overwrite button 1328 in a state where the original data is selected, the screen illustrated in FIG. 14 is displayed, enabling the user to select a method of inputting data that has been updated (hereinafter referred to as “updated data”), which is used for the overwriting. In inputting the updated data by reading the original whose content has been updated by using the scanner 180 as in the first embodiment, the user selects a button 1801 to display the screen illustrated in FIG. 10. On the other hand, in reading the data that is stored in the box that is set in the HDD 108 of the multifunction peripheral 200 as the updated data, the user selects a button 1802 to display the screen illustrated in FIG. 15.

The operation described above corresponds to the processing in steps 2001 through 2003 in the flow chart of FIG. 16. That is, when the user selects the overwrite button 1328, the overwrite mode is set in step 2001. Then, according to the selection by the user made via the screen illustrated in FIG. 14, a determination is made in step 2002. If the reading of an original is instructed (SCAN in step 2002) as in the case of the first embodiment, the processing advances to the processing in the flow chart of FIG. 13, and the subsequent processing is performed in a similar way as described in the first embodiment. On the other hand, if the reading of data from the box is instructed (BOX in step 2002), the processing advances to step 2003 to display the screen illustrated in FIG. 15.

In FIG. 15, as in the user box subscreen illustrated in FIG. 9, attribute information of the data stored in the HDD 108 is displayed in a list 1910. The original data that is selected via the screen illustrated in FIG. 9 cannot be selected as the updated data and thus, the original data is not displayed in the screen illustrated in FIG. 15. When the user selects an OK button 1921 after selecting the desired data, the screen illustrated in FIG. 11 is displayed. The processing is then performed in a similar manner as described in the first embodiment.

Returning to the flow chart of FIG. 16, when selection of the OK button 1921 is detected in step 2003, the processing advances to step 2004. In step 2004, the CPU 101 reads data selected as the updated data from the HDD 108. Then, in step 2005, the CPU 101 causes the difference data extraction unit 117 to extract difference data between the read updated data and the original data, and then the processing advances to step 2006. The processing associated with steps 2006 through 2009 are similar to the processing described above with respect to the first embodiment, thus, a detailed description is omitted herein. If selection of a cancel button 1922 is detected in step 2003, the processing advances to step 2009 to cancel the overwrite mode. The processing then ends.

In the present embodiment, the data stored in the HDD 108 of the multifunction peripheral 200 is read as the “updated data”. However, data stored in the storage area of the file server 212 can be acquired as the “updated data”. In this case, the screen illustrated in FIG. 15 displays a list of attribute information of the data stored in the file server 212, and the user specifies data to be the “updated data” from among the listed data.

In the present embodiment, difference data is extracted from the updated data stored in a given storage area to perform the overwrite printing. Accordingly, wasting of print paper can be prevented.

### Third Exemplary Embodiment

Now, a third exemplary embodiment of the present invention will be described. Portions of the configuration that are similar to those of the configuration of the first and second exemplary embodiments are provided with the same reference numerals and symbols, thus, their detailed descriptions are omitted herein. One difference between the third embodiment and the first and second exemplary embodiments is that in the first and second exemplary embodiments, the data that includes only one page is used, while in the third embodiment, the data including a plurality of pages is used for the overwrite printing. Note that in the third embodiment, for description purposes, an example is provided in which the updated original used for overwriting is read and input. The same function can be applied to the second embodiment as well.

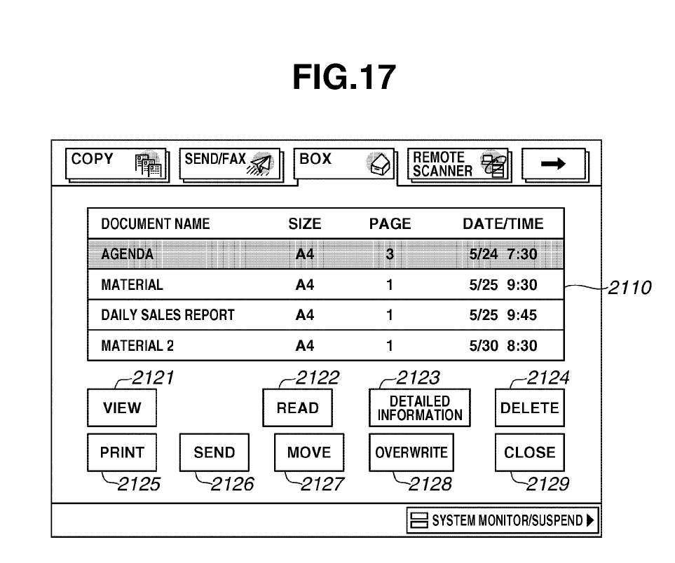

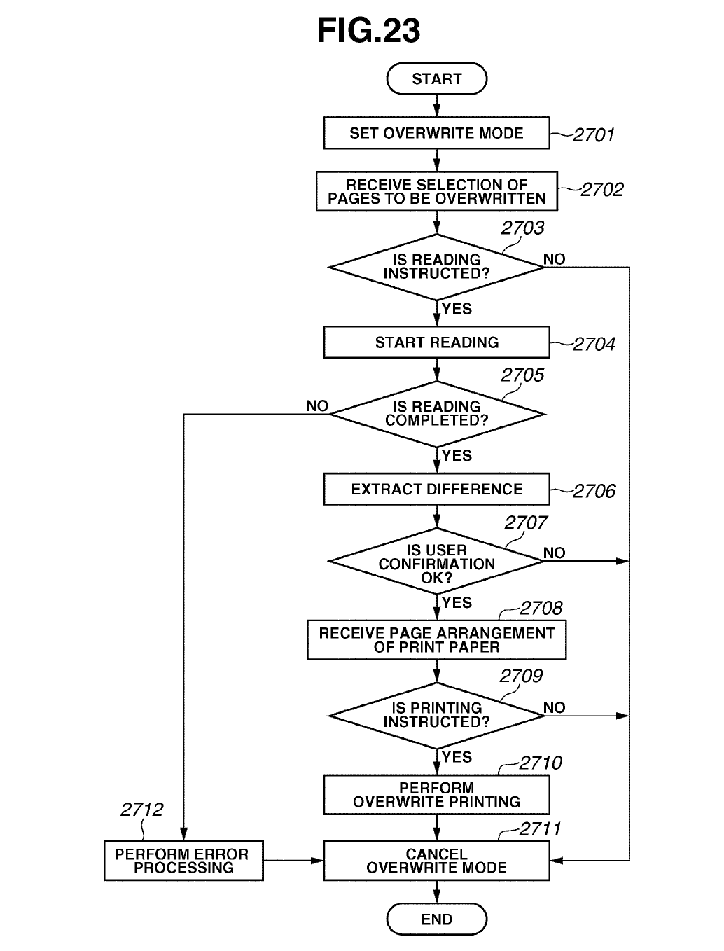

The operation and the flow of processing of the overwrite printing are described in detail with reference to the screens illustrated in FIGS. 17 through 22 and the flowchart illustrated in FIG. 23. FIG. 23 is a flowchart that illustrates the operation of control by the CPU 101 of the multifunction peripheral 200 in performing the overwrite printing.

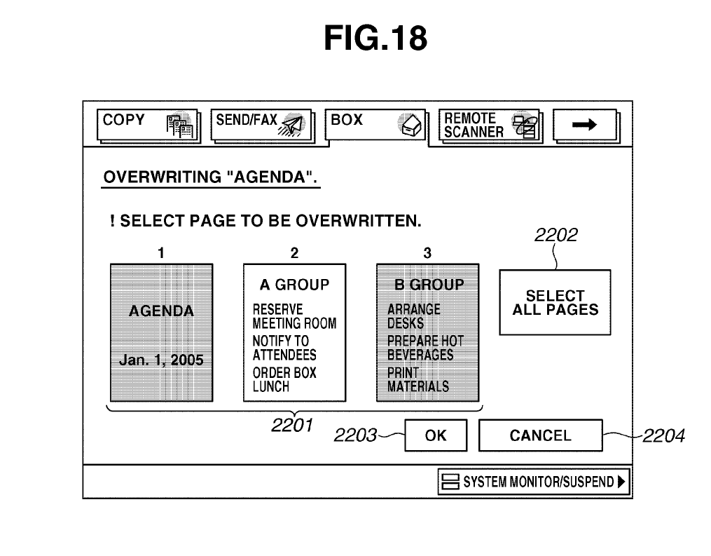

First, as in the first and second exemplary embodiments, the user selects data to be overwritten (hereinafter referred to as “original data”) via the screen illustrated in FIG. 17. Buttons 2121 through 2129 are similar to the buttons 1321 through 1329 illustrated in FIG. 9. When the user selects an overwrite button 2128 in a state where given data is selected, the screen illustrated in FIG. 18 is displayed, prompting the user to specify the page to be overwritten.

FIG. 18 illustrates a screen in which a preview image of each page of the original data is displayed in a display area 2201. The user can specify the page to be overwritten by touching the preview image of the desired page. In the present example, pages 1 and 3 are selected. In addition, in the case where all of the pages are to be overwritten or in the case where only some pages are to be overwritten and all the pages are to be read as the original updated for overwriting, the user selects an all-page selection button 2202 to select all of the pages.

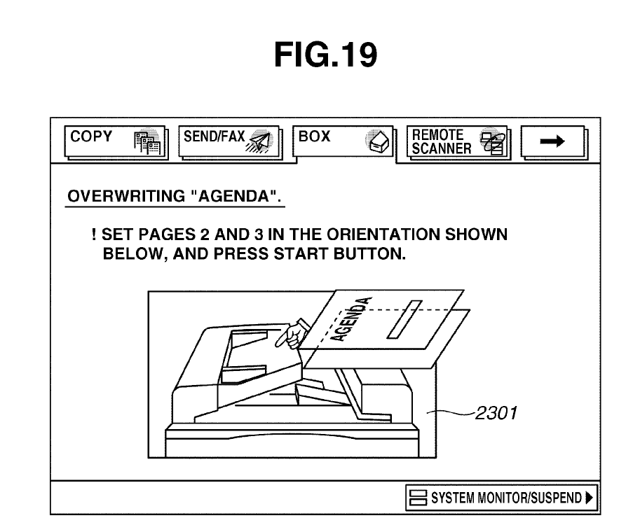

The operation described above corresponds to the processing in step 2701 in the flow chart of FIG. 23 for setting the overwrite mode in response to the selection of the overwrite button 2128 illustrated in FIG. 17. Then, in step 2702, the CPU 101 receives the specification for the page to be overwritten by the user. This processing is performed upon selection of the OK button 2203 illustrated in FIG. 18. Then, in step 2703, the CPU 101 determines whether the user has instructed reading. At this point, the screen illustrated in FIG. 19 is displayed by the liquid crystal panel unit 801. In a display area 2301, a procedure is displayed so that a right side and orientation can be recognized in setting an updated original into the document feed unit 302 by using the preview image of the original data.

When it is determined in step 2703 that the user has selected the start button 802 after setting the original in the scanner 180 according to the procedure illustrated in the display area 2301, the processing advances to step 2704 to start the reading of the original by the scanner 180. If a given period of time elapses in a state where the screen illustrated in FIG. 19 is displayed, or if the user selects the reset key 803, it is determined in step 2703 that an instruction for reading has not been issued. Then, the processing advances to step 2711 to cancel the overwrite mode. The processing then ends.

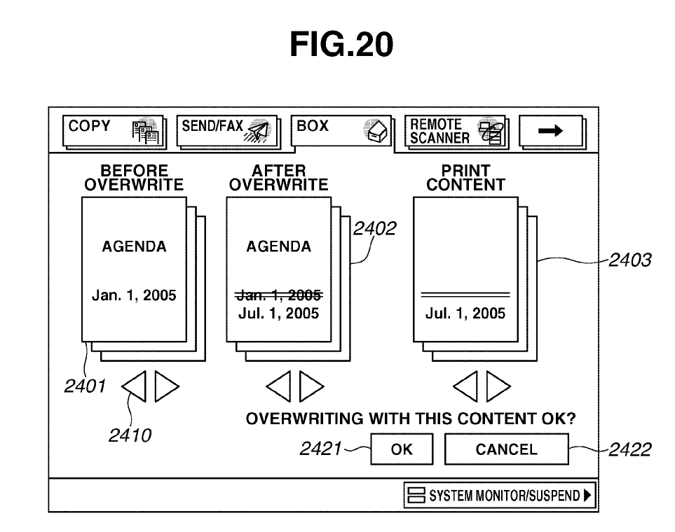

In step 2705, as in the first exemplary embodiment, the CPU 101 determines whether the reading of an image on the original is completed. The processing advances to step 2706 or step 2712 based on a result of the determination. If the processing advances to step 2706 (YES in step 2705), the CPU 101 compares the original data with the updated data that is read by the scanner 180 (hereinafter referred to as “updated data”). Then, the CPU 101 causes the difference data extraction unit 117 to extract difference data between the original data and the updated data (hereinafter referred to as “difference data”). Then, the processing advances to step 2707 to display the screen illustrated in FIG. 20 by the liquid crystal panel unit 801.

FIG. 20 illustrates an example of the screen displayed when the reading of an image on the original for overwriting is completed. In a display area 2401, a preview image of the original data is displayed as “before overwrite”. In a display area 2402, a preview image of the updated data is displayed as “after overwrite”. In the present example, an “agenda” that is printed as the original data includes a description “Jan. 1, 2005”, but in the updated data that is overwritten, the description on the date is provided with strike-through and is changed to “Jul. 1, 2005”.

In a display area 2403, a preview image of the difference data that is extracted in step 2706 in the flow chart of FIG. 23 is displayed as “print content”. More specifically, only the strike-through “=” and the character string “Jul. 1, 2005”, which were added to the original data via hand mark-ups, are extracted to be ready for the print data for overwriting. When the user operates a cursor 2410, preview images for page 2 and subsequent pages are displayed.

When the content displayed by the preview is satisfactory to the user, the user selects an OK button 2421, but if the user wishes to redo the reading, the user selects a cancel button 2422. In this case, referring to the flow chart of FIG. 23, if it is determined in step S2707 that the user has selected the OK button 2421, the processing advances to step 2708, where the user is prompted to specify an arrangement order for the print papers. If it is determined that the user has selected the cancel button 2422, the processing advances to step 2711 to cancel the overwrite mode. The processing then ends.

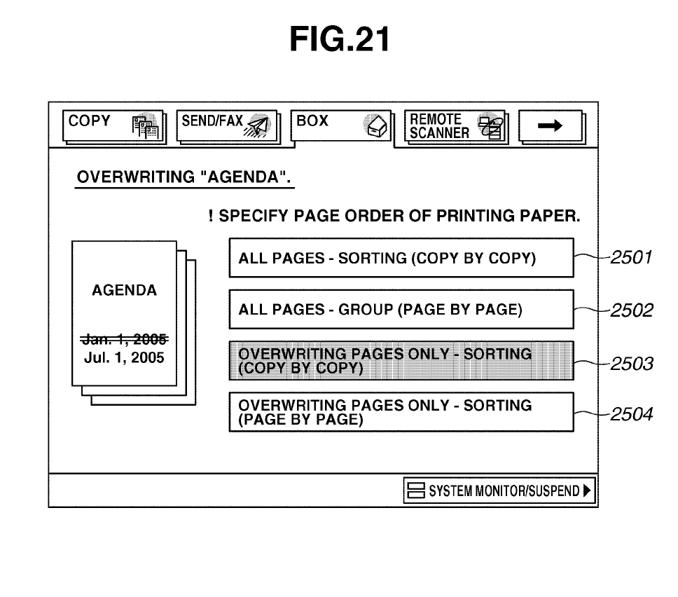

FIG. 21 illustrates a screen displayed by the liquid crystal panel unit 801 in step 2708. The user specifies information concerning the paper for printing via the screen. In the present embodiment, the papers printed based on the original data including a plurality of pages are fed to perform the overwrite processing of portions to be updated. In this regard, if the arrangement order of the printed papers to be fed is incorrect, print data for overwriting (difference data) for a wrong page is undesirably printed. By allowing the user to specify the arrangement order of the printed papers to be fed through the screen illustrated in FIG. 21, this type of printing failure can be prevented.

A user makes a selection in order to either feed all of the pages or to feed only the pages for overwriting. Feeding of all of the pages includes setting all of the pages, including the pages that are not to be overwritten, i.e., the printed papers that are not set as originals at the time of reading in step 2704, in the paper feed cassette 329. Feeding of only the pages for overwriting includes setting only the printed papers of pages that are actually read in step 2704 in the paper feed cassette 329.

A user can also select either one of “sorting” or “grouping”. In the sorting mode, the papers are discharged copy by copy at the time of printing. That is, in the sorting mode, the pages are arranged in the following order: page 1, page 2, page 3, page 1, page 2 . . . . In the grouping mode, the papers are discharged page by page at the time of printing. That is, in the grouping mode, the pages are arranged in the following order: page 1, page 1, page 1 . . . , page 2, page 2 . . . .

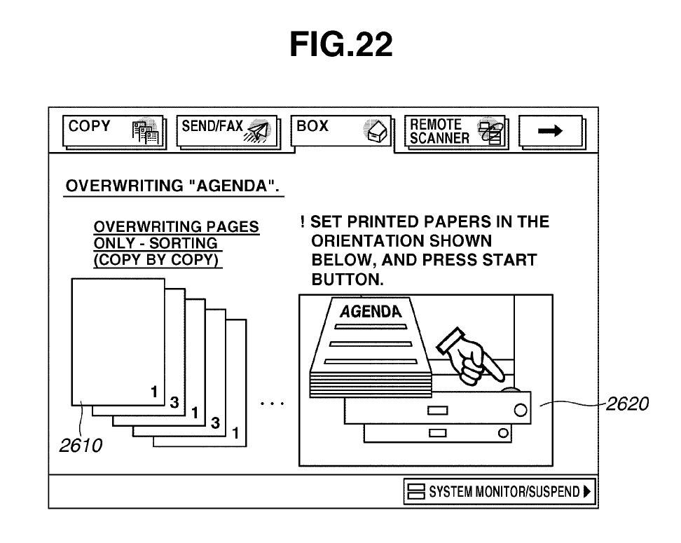

The user selects from combinations of the alternatives by touching either one of the areas 2501 through 2504 in FIG. 21. The example illustrated in FIG. 21 is a state where “overwriting pages only—sorting” in the area 2503 is selected. When user make the selection, the selected content is read. Then, the liquid crystal panel unit 801 displays a screen illustrated in FIG. 22.

FIG. 22 illustrates a screen prompting the user to set the print papers. In a display area 2610, a content of a completed output after the overwrite printing is performed, i.e., a preview image of the original read in step 2704, is displayed. Each numeral displayed on the preview image indicates a page number. That is, the user selects the “overwriting pages only—sorting”, and accordingly, pages 1 and 3, which are to be actually overwritten, are arranged in the order of “sorting”. In a display area 2620, a procedure indicating the side and orientation of setting the print papers onto which the original data is printed in the paper feed cassette 329 is displayed by using the preview image of the original data.

When the print papers are completely set, the user selects the start button 802 to start the printing. This instruction corresponds to the processing in step 2709. When the user selects the start button 802, the processing advances to step 2710 to start the overwrite printing. If a given period of time elapses in a state where the screen illustrated in FIG. 22 is displayed, or if the user selects the reset key 803, it is determined in step 2709 that an instruction for printing has not issued. Then, the processing advances to step 2711 to cancel the overwrite mode. The processing then ends. When the overwrite printing is completed, the processing advances to step 2711 to cancel the overwrite mode. The processing then ends.

The content of the overwrite printing in step 2710 differs depending on which of the “(feed) all pages” or “(feed) the overwriting pages only” is selected by the user. That is, when only the overwriting pages are fed, the print data for overwriting (difference data) is read and the print data is printed as is. However, when all of the pages are fed, the print papers of pages that are not selected via the screen illustrated in FIG. 18 are fed to be discharged without performing print processing. Thus, the printed paper having a content corresponding to the page included in the updated data can be appropriately overwritten.

In the present embodiment, the user can specify the pages to be overwritten via the screen illustrated in FIG. 18. However, the corresponding pages can be automatically determined by comparing the original data with the updated data. More specifically, with respect to each page included in the original data and each page included in the updated data, a similar image determination unit 118 determines to which page of the original data each page of the updated data corresponds by using a publicly known technique (e.g., a technique for determining a degree of similarity by using an amount of characteristic of an image). Thus, the user does not need to specify the pages to be overwritten.

In addition, in the present embodiment, the user can select from between “(feed) all pages” and “(feed) overwriting pages only” in specifying the printed papers that are set in the paper feed cassette 329. A similar selection can be applied to a case where the originals are set in the document feed unit 302. That is, in setting the originals including an updated content in the document feed unit 302, the reading of the originals starts after the user selects from between “setting all the pages” and “setting updated pages only”.

According to the present embodiment, the overwrite printing of data including a plurality of pages can be performed by extracting difference data from the updated data. Accordingly, wasting of print papers can be prevented.

Note that the following configurations are applicable to the above described embodiments. For example, in each overwrite printing step (steps 1708, 2008, and 2710), a “trial printing” mode can be provided in which first the paper is temporarily stopped in a state where one page (or one part) only is overwrite-printed to allow the user to confirm the print content. Thus, the user can correct the content if the difference data is incorrect or if the print papers are set in a wrong orientation, thus preventing failure in printing in a large number of papers.

In addition, when the overwrite mode is set, other print jobs can be suspended. Thus, when the papers are set in the paper feed cassette 329 and the user performs various settings, a failure such that the papers that are set for a print job from other terminal devices or for receiving a facsimile are undesirably fed and printed can be prevented.

The user of the overwrite printing function can be restricted by the user authentication performed via the screen illustrated in FIG. 5. For example, users who can access each data stored in the HDD 108 can be previously set or a user who can select the data to be overwrite-printed can be previously set. Thus, security can be improved.

In the above described embodiments, the original data can be selected from among the data stored in the HDD 108. However, the data can be stored in another device on a network. For example, as illustrated in FIG. 2, the data stored in a storage area of the PC 211, the file server 212, or another MFP 213 can be selected as the original data or the updated data. Thus, the overwrite processing can be performed by a terminal different from a terminal that performs printing first.

In addition, for the original data in the above described embodiments, the data that is read by the scanner 180 and temporarily stored in the memory 106 can be selected. Thus, by reading the original having the “original data” printed thereon and then reading an image on the original having the “updated data”, the difference data can be extracted by inputting the “original data” and the “updated data”.

In extracting difference data, a color for the portion to be updated or a color for the portion of the content before updating can be specified. For example, when the difference is extracted by specifying the color for the content before updating is black and the color for the updated content is red, the difference data can be extracted at a higher accuracy.

The present invention can be applied to a system including a plurality of devices (e.g., a computer, an interface device, a reader, a printer, a file server) and to an apparatus that includes one device (e.g., a network multifunction peripheral).

The present invention can also be achieved by providing a system or a device with a storage medium (or a recording medium) which stores program code of software implementing the functions of the embodiments, and by reading and executing the program code stored in the storage medium with a computer of the system or the device (a CPU or an MPU). In this case, the program code itself, which is read from the storage medium, implements the functions of the embodiments mentioned above, and accordingly, the storage medium storing the program code constitutes the present invention. In addition, the functions according to the embodiments described above can be implemented not only by executing the program code read by the computer, but also implemented by the processing in which an operating system (OS) or the like carries out a part of or the whole of the actual processing based on an instruction given by the program code.

After the program code read from the storage medium is written in a memory provided in a function expansion board inserted in the computer or in a function expansion unit connected to the computer, a CPU and the like provided in the function expansion board or the function expansion unit can carry out a part of or the whole of the processing to implement the functions of the embodiments as described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-372524 filed Dec. 26, 2005, which is hereby incorporated by reference herein in its entirety.

What is claimed is:

1. A printing apparatus comprising:
a storage unit configured to store first data including a plurality of pages;
an input unit configured to input second data including a plurality of pages by reading an image of an original using a reading apparatus;
an extraction unit configured to extract difference data by comparing the first data stored in the storage unit with the second data input by the input unit;
a display unit configured to display a preview of the difference data;
a selection unit configured to select a page according to a designation by a user, the user designating the page based on the preview displayed by the display unit;
a loading unit configured to load a recording medium having the first data printed thereon; and
a printing unit configured to perform overwrite printing by printing the difference data of the page selected by the selection unit on the recording medium loaded in the loading unit.

2. The printing apparatus according to claim 1, wherein the display unit is configured to display a procedure for inputting the second data by the input unit.

3. The printing apparatus according to claim 1, wherein the display unit is configured to display a procedure for loading the recording medium into the loading unit.

4. The printing apparatus according to claim 3, wherein the procedure includes displaying an orientation of the recording medium with respect to the loading unit.

5. The printing apparatus according to claim 1 further comprising a control unit configured to control the printing unit to perform the overwrite printing on the page selected by the selection unit based on the difference data.

6. A printing apparatus comprising:
a storage unit configured to store first data including a plurality of pages;
an input unit configured to input second data including a plurality of pages;
an extraction unit configured to extract difference data by comparing the first data stored in the storage unit with the second data input by the input unit;
a loading unit configured to load at least one recording medium having the first data printed thereon; and
a printing unit configured to perform overwrite printing by printing the difference data on the at least one recording medium loaded in the loading unit;
wherein, when a recording medium for a page from which difference data is not extracted is loaded into the loading unit with a recording medium from which difference data is extracted, the printing unit performs overwrite printing on the recording medium from which the difference data is extracted before discharging the recording medium and discharges the recording medium from which difference data is not extracted without performing overwrite printing on the recording medium.

7. A printing apparatus comprising:
a storage unit configured to store first data including a plurality of pages;
an input unit configured to input second data including a plurality of pages;
an extraction unit configured to extract difference data by comparing the first data stored in the storage unit with the second data input by the input unit;
a loading unit configured to load at least one recording medium having the first data printed thereon;
a printing unit configured to perform overwrite printing by printing the difference data on the at least one recording medium loaded in the loading unit; and
a setting unit for setting a discharge mode of the printing unit;
wherein when the discharge mode is set to sorting, the printing unit performs the overwrite printing on a copy-by-copy basis, and
wherein when the discharge mode is set to grouping, the printing unit performs the overwrite printing on a page-by-page basis.

8. A system for printing, the system comprising:
a network;
at least one computing apparatus;
a printing apparatus, the printing apparatus comprising:
a storage unit configured to store first data including a plurality of pages;
an input unit configured to input second data including a plurality of pages by reading an image of an original using a reading apparatus;
an extraction unit configured to extract difference data by comparing the first data stored in the storage unit with the second data input by the input unit;
a display unit configured to display a preview of the difference data;
a selection unit configured to select a page according to a designation by a user, the user designating the page based on the preview displayed by the display unit;
a loading unit configured to load a recording medium having the first data printed thereon; and
a printing unit configured to perform overwrite printing by printing the difference data of the page selected by the selection unit on the recording medium loaded in the loading unit;
wherein the at least one computing apparatus and the printing apparatus are connected via the network.

9. The system according to claim 8, wherein the display unit is configured to display a procedure for inputting the second data by the input unit.

10. The system according to claim 8, wherein the display unit is configured to display a procedure for loading the recording medium into the loading unit.

11. The system according to claim 10, wherein the procedure includes displaying an orientation of the recording medium with respect to the loading unit.

12. The system according to claim 8, wherein the printing apparatus further comprises a control unit configured to control the printing unit to perform the overwrite printing on the page selected by the selection unit based on the difference data.

13. A method for printing, the method comprising:
storing first data including a plurality of pages on a storage medium;
inputting second data including a plurality of pages by reading an image of an original;
extracting difference data by comparing the stored first data with the input second data;
displaying a preview of the difference data;
selecting a page according to a designation by a user, the user designating the page based on the preview;
loading a recording medium having the first data printed thereon; and
performing overwrite printing by printing the difference data of the page selected on the loaded recording medium.

14. The method according to claim 13, further comprising displaying a procedure for inputting the second data.

15. The method according to claim 13, further comprising displaying a procedure for loading the recording medium.

16. The method according to claim 15, wherein the procedure includes displaying an orientation for loading the recording medium.

17. The method according to claim 13, further comprising controlling the overwrite printing such that the overwrite printing is performed on a selected page based on the difference data.

18. A computer-readable storage medium storing computer-executable process steps, the computer-executable process steps causing a computer to execute the method of claim 13.

19. A method for printing, the method comprising:
storing first data including a plurality of pages on a storage medium;
inputting second data including a plurality of pages;
extracting difference data by comparing the stored first data with the input second data;
loading a recording medium having the first data printed thereon;
performing overwrite printing by printing the difference data of the page selected on the loaded recording medium.
wherein, when a recording medium for a page from which difference data is not extracted is loaded with a recording medium from which difference data is extracted, overwrite printing is performed on the recording medium from which the difference data is extracted before discharging the recording medium and the recording medium from which difference data is not extracted is discharged without performing overwrite printing on the recording medium.

20. A computer-readable storage medium storing computer-executable process steps, the computer-executable process steps executing the method of claim 19.
